(19) United States
(12) Patent Application Publication
(10) Pub. No.: US 2008/0140481 A1
(43) Pub. Date: Jun. 12, 2008

(54) METHOD AND SYSTEM FOR GENERATING ADVERTISEMENT

(76) Inventor: Josh Todd Gold, Newport Coast, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/948,805

(22) Filed: Nov. 30, 2007

Related U.S. Application Data
(60) Provisional application No. 60/868,930, filed on Dec. 6, 2006.

(51) Int. Cl. G06Q 30/00; G06F 17/00

(52) U.S. Cl. 705/7; 705/14

(57) ABSTRACT

Systems and methods for automated management and compilation of advertising for a real world event depiction are provided. The system includes utilizing a presentation content production pipeline, where during the event presentation operation a set of rules for the determination of aspects of the available managed advertising is established. Additionally, the system includes the interpretation of those rules and the implementation of those interpretations establishes the managed advertising selected from the available managed advertising for inclusion in the event presentation and may also establish aspects of the implementation of the managed advertising in the event presentation. The method also establishes a set of rules for the determination of a corresponding set of analytic results during the event presentation operation. Each rule specifies at least how to form the analytic result from one or more analytic measurements. Each analytic measurement may be based on the representation of aspects within the presentation content of the advertisements measured by the analytic measurement.

### CROSS-REFERENCE TO RELATED APPLICATIONS

This application claims priority from U.S. Provisional Application Ser. No. 60/868,930, filed Dec. 6, 2006, which is incorporated herein by this reference in its entirety.

### TECHNICAL FIELD

This invention relates generally to the field of advertising within a depiction of a real world event, and more particularly some embodiments relate to a system and method for generating advertisement based on simulated depiction of a real world event.

### DESCRIPTION OF THE RELATED ART

Advertising is common in presentations of real world events, such as live and recorded televised sporting events. Such advertising has many forms, including inserted into breaks in the presentation of the event or overlaid on a portion of the screen during the presentation of the event. Advertising is also frequently placed on real world objects in or near the event, such as on event participants, participating objects such as vehicles, and in the immediate event area, with the intention that such advertising may appear within the televised presentation. A recently introduced advertising method simulates advertising placed in the real world space by inserting computer generated advertising into the televised presentation of the event so that the advertisement appears to be part of the real world being viewed, such as on sections of roadway, playing field, or boundary walls.

These currently available advertising options have limited use, due in part to the automated systems which place the advertising having little or no information about the three dimensional structure of the depicted event. This limits the options for advertisements which appear to be part of the event to existing advertising at the event, and to the very limited use of computer generated advertising simulated to exist at the event.

Advertisements placed at the event may be changed only by physically changing the advertisement, and such advertising appearing in the presentation of the event is seen unchanged by all viewers of the presentation. This frequently results in, for example, advertisements targeted to one specific region being shown to the global audience of the presentation, such as advertisements targeted to an audience local to the event or to some larger region, where such advertisements are not effective for the global audience due to the local orientation of those advertisements. This results in the targeted advertisements effective for only a limited portion of the presentation viewing audience.

Computer generated advertising inserted into the presentation as described above requires careful measurement, calibration, and instrumentation of the cameras and surfaces used for views using this advertising method, and the locations where such advertising may be placed are very limited. As a result, for example, advertising placed on moving objects is not possible, and advertising placed in views of cameras not calibrated and instrumented or where the calibration was flawed or the instrumentation is not working correctly is not possible.

Analysis of the effect, or potential effect, of advertising on viewers is of great importance to both those purchasing advertising space and those selling advertising space. A major factor in the determination of the effect of an advertisement is a measurement of the amount of time the advertisement appears in the presentation, along with a measurement of how visible or perceptible the advertisement is during its appearance. Performing these measurements on advertisements placed at the event is not possible using automated means because no automated means exist which can recognize such advertisements and determine their visibility. In this case these measurements must be made by one or more persons viewing the presentation, possibly multiple times, and performing these measurements manually. This introduces the probability of unreliable measurements due to the subjective nature of the viewers' opinions, resulting in measurement differences between viewers, and measurement differences during a viewing or across viewings by a viewer.

### BRIEF SUMMARY OF EMBODIMENTS OF THE INVENTION

According to the present invention, disadvantages, limitations, and problems associated with previous systems and methods for providing, including, and analyzing the effectiveness of advertising within a presentation of a depiction of a real world event have been substantially reduced or eliminated when the present invention is used in conjunction with the presentation of the real world event from a depiction represented as a computer simulation of the real world event.

The present invention provides for advertising within or overlaid over a depiction of a real world event represented as a computer simulation. In such a depiction, an advertisement may take any form available within the capabilities of the presentation content production producing the presentation content of the event presentation. The present invention provides for rendering of an advertisement using a rendering algorithm or rendering algorithm parameters different than the default rendering algorithm or rendering algorithm parameters, as well as other advertisement specific customizations affecting the advertisements rendered form. The present invention includes systems and methods for the determination of which advertisements are placed in the presentation, and the determination of the content, location, and timing of those placed advertisements. The determination includes broad flexibility in where the determination is performed, when the determination is performed, and who performs the determination, including, but not limited to, the final determination as a result of one or more previous partial determinations by separate entities remote in location and time. The content of advertisements may include information from sources local or remote to the presentation system, including, but not limited to, information specific to the presentation system, viewer, or user. The present invention includes systems and methods providing viewer interaction with advertisements where the viewer uses a human interface device communicating with the presentation system to indicate or detect information, such as a location or action or both. Advertising content interactive functions may use this indicated or detected information for a variety of uses.

According to the present invention, during the presentation the presentation system has detailed information about what is presented to the viewer through the presentation devices. This detailed presentation information is used by the present invention for gathering analytic information on the advertising or potential advertising within the presentation. A broad range of analytic information may be gathered, including information specific to the presentation system performing the presentation. Advertising analytics gathered according to the present invention may be transmitted to locations remote to the local presentation system for storage or for further analysis. Where such advertising analytics transmittal is not immediately available, the gathered advertising analytics may be saved by the presentation system until the transmittal of those advertising analytics becomes available.

The present invention provides systems and methods related to charging fees for including advertising within a presentation as described above, including, but not limited to, means to specify and price advertising space to advertisers, means for advertisers to select and purchase advertising space, means for advertisers to preview advertising content for an advertising space, means for advertisers to provide advertising content for an advertising space, means to sell advertising analytics, and means to provide advertising analytics to advertising analytics consumers.

In still another embodiment of the present invention, a method for managing advertisement in an event presentation is provided. The method includes: establishing an advertising content to determine available managed advertisements for the event presentation; determining an advertising rule based on the advertising content; determining a set of the available managed advertisements to be included in the event presentation based on the advertising rule; and modifying the even presentation based on the determined set of available managed advertisements and the advertising rule.

In yet another embodiment, the managed advertisements are implemented in the event presentation by modifying one or more production collections used by the presentation content production of the event presentation, such that the modifications are according to the presentation specifics of the managed advertisements.

In still another embodiment, the advertising rule is determined concurrent with the event presentation. Alternatively, the advertising rule is determined based on a narrative event or a characteristic of a real world event.

In yet another embodiment, the narrative and the real world event comprise a human interface for a presentation content user to select one or more user specified depiction of the event presentation.

In still another embodiment, the set of available managed advertisements is based on a state of a renderer.

In accordance to another embodiment of the present invention, a system for managing advertisement in an event presentation includes: a first content generator configured to generate advertising content, wherein the advertising content determines available managed advertisements for the event presentation; a rule module configured to determine an advertising rule for the advertising content; an advertisement module configured to determine a set of available managed advertisements to be included in the event presentation based on the determined advertising rule; and a second content generator configured to manage the event presentation by modifying the event presentation based on the determined set of available managed advertisements and the advertising rule.

In still another embodiment, the managed advertisements are implemented in the event presentation by modifying one or more production collections used by the presentation content production of the event presentation, such that the modifications are according to the presentation specifics of the managed advertisements.

In still another embodiment, the advertising rule is determined concurrent with the event presentation. Alternatively, the advertising rule is determined based on a narrative event or a characteristic of a real world event.

In another aspect according to an embodiment of the present invention, a method for compiling advertising analytics for an event presentation is provided. The method includes: establishing an analytic measurement on a characteristic of the event presentation; generating an analytic directive based on the established analytic measurement; and creating a transformed form based on the generated analytic directive as the advertising analytics, wherein the transformed form is stored or transmitted to a remote device.

In still another embodiment, the analytic measurement comprises a perceptibility measurement. In an embodiment, the perceptibility measurement comprises a user perception of the characteristic of the event presentation.

In yet another embodiment, the analytic measurement comprises a measurement of a mouse pointer position.

In still another embodiment, the characteristic comprises the coverage area or size of the event presentation with respect to a display device the event presentation is being presented.

In yet another embodiment, the advertising analytic comprises information of a presentation system used to exhibit the event presentation.

In accordance to another embodiment of the present invention, a system for compiling advertising analytics for an event presentation includes: a first module for establishing an analytic measurement on a characteristic of the event presentation; a second module for generating an analytic directive based on the established analytic measurement; and a third module for creating a transformed form based on the generated analytic directive as the advertising analytics, wherein the transformed form is stored or transmitted to a remote device.

In yet another embodiment, the advertising analytic comprises information of a presentation system used to exhibit the event presentation.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 illustrates an exemplary system for supplying and delivering real world event content with included and dynamically served advertising, and an exemplary system for the presentation of said content and advertising, and an exemplary system for the delivery of the advertising analytics resulting from said presentation according to embodiments of the present invention.

FIG. 1 illustrates an exemplary system for supplying and delivering real world event content to be used in generating advertising content according to an embodiment of the present invention.

FIGS. 2-7 illustrate exemplary process flow charts that can be implemented by the advertising system of FIG. 1 according to embodiments of the present invention.

FIGS. 8-9 illustrate examples of advertising content data sets generated using the advertising system of FIG. 1 according to embodiments of the present invention.

FIG. 10 illustrates an exemplary computer system in which the present invention can be implemented.

The figures are not intended to be exhaustive or to limit the invention to the precise form disclosed. It should be understood that the invention may include practiced with modification and alteration, and that the invention be limited only by the claims and the equivalents thereof.

### DETAILED DESCRIPTION OF THE EMBODIMENTS OF THE INVENTION

### 1. Definitions

Before describing the invention in detail, it is useful to define some of the terms found herein.

Recorded content may include an event content available to the presentation system substantially in the form of one or more data sets, where the event content for use in an event presentation is available in whole or in substantial part to the presentation system prior to the event presentation. Recorded content may additionally include streamed content. Recorded content may be available to the presentation system either on a pre-recorded locally accessible data storage, such as, for example a DVD, or on a recordable locally accessible data storage device.

Streamed content may include an event content available to the presentation system substantially in the form of a stream of data or broadcasted data received from a remote location, where the event content for use in an event presentation is not available in whole to the presentation system prior to the event presentation, and where the event content is streamed substantially in order of presentation, such that the event content is streamed at least in part during the event presentation.

Recorded presentation may include an event presentation of a recorded content.

Streamed presentation may include an event presentation of a streamed content.

Event content supplier may include an entity, such as an event content distributor, which supplies event content, and may also supply advertising content, to a presentation system.

Advertising server may include an entity, system, or apparatus that supplies advertising content, advertising determination information, or advertising determination decisions to a presentation system.

Advertising supplier may include an entity which supplies advertising content, or other content or information which is used to produce advertising content.

Managed advertising component may include the functionality of the portion of the presentation operation performing advertising determination and implementation of the resulting managed advertisements.

Advertising analytics component may include the functionality of the portion of the presentation operation interpreting analytic directives, implementing the interpreted analytic directives in the form of analytic measurements performed during presentation performance and forming any analytic directive resultants from the analytic measurements, producing the transformed forms formed from the analytic directive resultants or other the transformed forms, and requesting the storage, retrieval from storage, or transmittal of analytic directive resultants or transformed forms.

Advertising content may include information containing specifics about how managed advertising is to be presented and used by a presentation system during an event presentation, where the information comprises determination rules. Examples of advertising content may include, but is not limited to, in formation used for rendering, such as locations, models, textures and animations, advertisement event information, advertisement priorities, and other advertising determination information.

Advertising determination may include a process of managed advertisement placement determination for an event presentation, comprising the interpretation of the determination rules portion of the advertisement content selected for the event presentation, where the managed advertisement placement determination includes, but is not limited to, determination of the managed advertisements placed in the event presentation and the presentation specifics for each the placed managed advertisement. Examples include, but are not limited to, the determination of included managed advertisements, and the determination of placement, rendering models, user interaction, animation, size, or timing for managed advertisements.

Determination rule may include instructions specifying the determination, or a contribution, in combination with one or more other determination rules, to the determination, of aspects of one or more managed advertisements for an event presentation, where the determination may rely on information specific to the event presentation, and where the aspects comprise one or more of the inclusion in the event presentation, the exclusion from the event presentation, or event presentation implementation specifics for one or more of the managed advertisements. Examples of the basis of the determination include, but are not limited to, advertisement location and priority, where for a plurality of advertisements sharing the same location only the highest priority advertisement is included, or user criteria, where the advertisement is included only if presentation system user information matches the user criteria, or advertisement location and visual rendering models selected from a plurality of locations and visual rendering models based on the narrative event being depicted and the date of event presentation.

Advertisement event may include an event, detectable by the presentation system, which may occur during the event presentation and which may be used by an event driven advertisement. Examples include, but are not limited to, the appearance of the advertisement in the presentation content, or the appearance of the advertisement within the presentation content meeting certain criteria, or the viewer, using a human interface device, indicates interaction intent with the advertisement, such as placing a cursor over the advertisement or positioning a cursor over a certain location on the advertisement and performing an additional action such as clicking a mouse button, or the virtual world lighting on the advertisement decreases past a certain level.

Unmanaged advertisement may include an advertisement incorporated in with the event content as supplied by the event content supplier, where the advertisement is integrated in to the event depiction, such that the advertisement does not depend on the functionality of the managed advertising component, although the advertisement may be subject to advertising determination. Examples include, but are not limited to, an advertisement incorporated into the visual model of a wall, building, roadway, or vehicle, where the model is part of the event content and the advertisement is not distinguished as such by the event content or presentation system.

Managed advertisement may include an advertisement determined by managed advertising component functionality.

Static advertisement may include a managed advertisement not dependent on an advertisement event.

Event driven advertisement may include a managed advertisement which depends on an advertisement event for some aspect of its presentation.

Potential advertisement may include a representation of a potential managed advertisement or potential unmanaged advertisement, where the advertisement does not exist, but where the representation specifies aspects of the advertisement sufficient for analytic measurement when the representation is used as an analytic unit. Examples include, but are not limited to, the location and size of an existing surface or nonexistent shape in the virtual world of an event depiction for which advertising analytics are desired.

Analytic unit may include an unmanaged advertisement, a managed advertisement, or a potential advertisement.

Analytic measurement may include a measurement based on a representation of an aspect of an analytic unit within the presentation content or viewer interaction with an analytic unit. Examples include, but are not limited to, perceptibility metrics compiled by, for consecutive time slices throughout the event presentation, calculating the percentage of display device screen space occupied by an advertisement then adding that time slice duration to a list of time sums indexed by the percentage, or enhancing the previous example by also calculating the percentage of distance along a line from the screen center to screen edge through the center of the advertisement then incrementing a counter in a two dimensional array of counters indexed by the previous example percentage then indexed by the current example percentage, or enhancing the previous example by adding an additional counter to the two dimensional array adding the time slice duration whenever the mouse pointer is over the advertisement for the time slice.

Analytic directive may include a specification for one or more analytic measurements and the specification for forming the analytic directive resultant from the results of the analytic measurements. Examples include, but are not limited to, instructions for performing 7 different analytic measurements on 3 specified advertisements combined as an analytic directive resultant, or enhancing the previous example by specifying that after presentation performance the analytic unit along with additional identifying information is to be stored then transmitted to a specified remote location when possible.

Analytic directive resultant may include results formed from one or more analytic measurements of an analytic directive.

Event depiction may include a representation of a narrative event from the event content core for the narrative event.

Event presentation may include an event depiction presented on presentation devices supplied with presentation content by presentation content production.

Presentation specification may include a description of the desired event depiction resulting from an event presentation.

Production characteristics may include characteristics which determine the style with which the event depiction is presented. Production characteristics do not change the history of the narrative event of the event depiction, where the history is originated from the event content core, but they do determine how the history is presented. Production characteristics may include, but are not limited to, the sequence of scenes with which each the narrative event is presented, characteristics for each camera and for each audio counterpart to a camera, such as position and movement path, artistic resources, such as lighting, music, and commentary, event element depictive resources, such as object models and sound effects, and sensory output device rendering style.

Presentation device may include a device whose purpose includes producing sensory output detectable by at least one sense. The device may be connected to one or more sources of content for the device by a communication means, and produces the sensory output depending on the content. Examples of such a device include, but are not limited to, a visual sensory output device, or display device, such as a television or monitor, and an audible sensory output device, or sound output device, such as a stereo or surround sound system.

Human interface device may include a device which interacts directly with a human user to take input from the user and enable the input to be transmitted to a computer in digital form. Examples include, but are not limited to, a mouse, keyboard, or joystick. Example uses include, but are not limited to, enabling the user to input data, indicate intentions, convey interest, or specify a selection.

Local system may include interconnected devices local to the viewing area of an event presentation, where the devices host the local functionality portion of the event presentation, comprising a presentation system, one or more presentation devices, and may include one or more human interface devices.

Presentation content may include a content in an encoding suitable for input to one or more presentation devices.

Production material may include one or more resources for use as input to one or more processes of the presentation content production, for use by the processes in the production of output resulting from that process.

Production instruction may include one or more rules specifying, controlling, or defining how production material is used in the operation of one or more processes of the presentation content production.

Production collection may include one or both of one or more production materials and one or more production instructions.

Simulation may include a virtual three dimensional reality generated by algorithms operating on one or more computational devices. A common example of a simulation is in a video game, where a virtual world is generated as a simulation by a computer.

Simulator asset may include a production material for use by a simulator. Simulator assets may include, but are not limited to, a virtual world object, and data or algorithms for controlling aspects of the virtual world object.

Renderer asset may include production material for use by a renderer. A simulation can be a renderer asset. Renderer assets also may include, but are not limited to, a model to use for a virtual world object for the rendering of that object.

Compositor asset may include a production material for use by a presentation content compositor. A rendering can be a compositor asset. Compositor assets may also include, but are not limited to, production material for use in overlaying, underlying, or replacing renderings, such as overlaying textual information or replacing videos for a display device, or overlaying narration or underlying music for a sound output device.

Simulator directive may include production instruction for use by a simulator. Simulator directives include, but are not limited to, control of the simulation temporal position, rate, or direction.

Renderer directive may include a production instruction for use by a renderer. Renderer directives include, but are not limited to, control of which model to use for the rendering of a virtual world object, and the position and direction within the simulation from which a rendering is generated.

Compositor directive may include a production instruction for use by a presentation content compositor. Compositor directives may include, but are not limited to, control of the content selected for overlaying, underlying, or replacing renderings, and control of the placement of renderings within the presentation content.

Available production assets may include available production materials which may be used by a presentation content production. Available production assets may also include simulator assets, renderer assets, and compositor assets, and may also include other production material as needed or available.

Available production directives may include available production instructions which may be used by a presentation content production. Available production directives may include simulator directives, renderer directives, and compositor directives, and may also include other production instructions as needed or available.

Available production collection may include available production assets and available production directives for a given presentation content production.

Presentation collection may include an event content core and a subset of the available production collection sufficient to enable an event presentation of a given presentation specification.

Presentation assets may include a subset of the available production assets used for the production materials portion of a presentation collection.

Presentation directives may include a subset of the available production directives used for the production instructions portion of a presentation collection.

Presentation operation may include an operation of an event presentation.

Presentation initiation may include a portion of the presentation operation where elements necessary for the presentation performance are made ready.

Presentation performance may include a portion of the presentation operation where the event depiction is presented on the presentation devices.

Presentation termination may include a portion of the presentation operation occurring after the presentation performance.

Simulator may include a process of operating a simulation.

Renderer may include a process of converting an aspect of a simulation into a form compatible with a presentation device of a given type and capability. A typical render operation may be the conversion of the view from a given position in a given direction within a simulation to a form suitable for transmission to a display device, or the conversion of the soundscape from a given position in a given direction within a simulation to a form suitable for transmission to a sound output device.

Compositor may include a process of composing presentation content from one or both of one or more renderings and other production material.

Presentation content production pipeline component may include a functionality of the portion of the presentation operation producing presentation content from a presentation collection, where production characteristics are determined by the production material and production instructions supplied to the functionality, the functionality comprising functionality for the operation of: one or more simulators, controlled by simulator directives, using simulator assets, and producing one or more simulations; one or more renderers, controlled by renderer directives, using the one or more simulations and other renderer assets, and producing renderings; one or more presentation content compositors, controlled by compositor directives, using the renderings and other compositor assets, and producing presentation content.

Presentation content production pipeline may include an operation of the presentation content production pipeline component.

Presentation content production may include an operation of producing presentation content for an event presentation, comprising the presentation content production pipeline.

Presentation system may include a system generating an event presentation, including operating the presentation operation and transmitting presentation content to the presentation devices.

Real world clock time span may include a span of clock time, bound by a start clock time and an end clock time, where the span may be formed from a measurement of real world time, a duration of real world time, and an offset of real world time, such that the start clock time is equal to the sum of the measurement and the offset, and such that the end clock time is equal to the sum of the measurement, the offset, and the duration, and where the offset is either implicit or is explicitly measured, and where the duration is either implicit or is explicitly measured, and where the start clock time and the end clock time implicitly, explicitly, or effectively share a common time scale. Examples include, but are not limited to, May 16, 2006 1:45 PM to May 16, 2006 3:00 PM local time, and May 16, 2006 05:47:32.843 UTC with an implicit error range of plus or minus 4 milliseconds. Examples of the time scale include, but are not limited to, Greenwich Mean Time, Coordinated Universal Time, the local time scale of some time zone, or some time scale based on one or more clocks.

Real world object may include a physical object in the real world. Examples include, but are not limited to, a solid, liquid, or gas body, or some collection of the bodies, such as a car, a person, the surface of an area of land, a road, a body of water, and a volume of air above an area of land.

Real world measurable quality may include a measurable quality of a real world object. Examples include, but are not limited to, size, mass, location, direction, velocity, acceleration, pressure, temperature, electric field, magnetic field, and many other physical properties of a real world object.

Real world measurement may include a value of a measurement of a real world quality of a real world object over a real world clock time span, or a composite measurement from a plurality of measurements of a real world quality of a real world object over a real world clock time span, where the value of the composite measurement and the corresponding real world clock time span of the composite measurement are calculated using interpolation, extrapolation, curve fitting, averaging, or some other algorithm, from the plurality of measurements. Examples include, but are not limited to, measurement of the location of a particular vehicle at a particular time, or a plurality of such measurements for the vehicle over a time span, and interpolating between the measurements using the time span to calculate the vehicle position at a particular time within the time span. Example uses of composite measurements include, but are not limited to, obtaining a likely measurement at a time when no measurement was actually made, such as at a time between two measurements, or to increase the accuracy of a measurement by averaging a plurality of measurements, or to increase or decrease the rate of measurements to a desired rate. For instance, a measurement of position of an object made at a rate of 75 times per second may be reduced to a measurement rate of 60 times per second.

Real world event may include a real world clock time span and a set of one or more real world objects, where for each the real world object there is set of real world measurements, where the real world clock time span for each the real world measurement is within the real world clock time span of the real world event. Examples include a motor sports event, where the position of the participating vehicles are measured at regular intervals during the duration of the event, or a sail boat race, where the position, hull speed, and air speed and direction of the participating boats, and the water current speed and direction at a set of fixed locations, and the air speed and direction at a set of fixed locations, are all measured at regular intervals during the duration of the event.

Real world measurement based virtual world value may include a virtual world value of a virtual world quality of a virtual world object over a virtual world clock time span, where the virtual world value reflects a real world measurement, and where the virtual world measurable quality corresponds to the real world quality of the real world measurement, and where the virtual world object corresponds to the real world object of the real world measurement, and where the virtual world clock time span corresponds to the real world clock time span of the real world measurement.

Non real world event may include a narrative event which does not meet the definition of a real world event. Examples may include a real world narrative event which is not represented by real world measurements, or a fictional narrative event.

Virtual world clock time span may include a span of virtual clock time, bound by a start virtual clock time and an end virtual clock time, within the virtual three dimensional reality of a simulation. The virtual three dimensional reality equivalent to the definition of real world clock time span for the real world. Examples include, but are not limited to, a representation within a simulation of a real world clock time span.

Virtual world object may include a virtual physical object within the virtual three dimensional reality of a simulation. The virtual three dimensional reality equivalent to the definition of real world object for the real world. Examples include, but are not limited to, a representation within a simulation of a real world object, such as a race track, a vehicle, a body of water, a building or other structure, the surface features of an area of land, or a volume of air, or a version of any of those example objects which are not real world objects.

Virtual world measurable quality may include a virtual measurable quality of a virtual world object. The virtual three dimensional reality equivalent to the definition of real world measurable quality for the real world. Examples may include, but are not limited to, a representation within a simulation of a real world measurable quality.

Narrative event may include a message that tells the particulars of an act or occurrence or course of events, or the telling of a story, consisting of a real world event or a non real world event, where the message is not dependent on interaction of a viewer of a presentation of the message for determination of the message, such as viewer game play, where a video game in particular is excluded as a narrative event.

Event content may include a production collection which represents a narrative event and is for use by presentation content production to produce presentation content depicting the narrative event, comprising event content core for the narrative event, if any, and event content non-core, if any.

Event content core may include a portion of the event content for a narrative event whose use in unchanged form in presentation content production is required in order for the depiction resulting from the production to be an accurate representation of the narrative event, where for a narrative event which is a real world event the portion of the event content comprises the set of real world measurement based virtual world values for each real world object from the real world event.

Event content non-core may include a portion, if any, of the event content which is not event content core.

### 2. Advertising Simulation System

Specific examples described herein of systems, methods, components, mechanisms, functionality, and algorithms for a dynamic advertising operation with respect to an embodiment of the present invention is primarily for illustration. Any practitioner of ordinary skill in the art can clearly see that alternate the choices could be substituted at any point without changing the scope or originality of the present invention.

The present invention involves advertising within or overlaid over a depiction of a real world event where the depiction is substantially represented as a computer simulation. In such a depiction, an advertisement may take any form available within the capabilities of the presentation content production producing the presentation content of the event presentation. These forms may include, but are not limited to, audio, video, images, objects with animations and behaviors, and combinations thereof. For example, these forms may or may not be made to appear as if they are a part of the real world being depicted, and may or may not represent actual advertisements existing in the real world of the event, and may or may not be bound by what is physically possible in the real world.

During the presentation of such a depiction, the presentation system, containing and operating the computer simulation, renders the computer simulation for one or more connected presentation devices, with possible pre or post render operations, producing presentation device content for the presentation devices, and transmits the presentation device content to the presentation devices. The presentation device content would include advertising as described herein. Examples of such advertising include, but are not limited to, advertising overlaid on the rendered simulation, such as a screen bug, banner advertisement, or audio advertisement, or advertising placed on or which is part of one or more simulated physical objects, such as a billboard, a sign, or a decal on a vehicle or piece of clothing, or advertising consisting of one or more simulated physical objects, such as an advertisers make and model of vehicle or an animated character representing an advertisers product.

The present invention includes a broad range of novel methods for the determination of which advertisements are placed in the presentation, and the determination of the content, location, and timing of those placed advertisements. The determination of these factors may be made at various times and by various determiners at diverse locations. The time that any specific determination is made can range from the time before the event content is created until just before the corresponding advertisement is to appear in the presentation. The determiner of any specific determination may include, but is not limited to, the computational device operating the computer simulation, the event content creator, and the advertising server or servers. The determination of these factors may include using information local or remote to the presentation of the event depiction, or information obtained from sources thereof, including, but not limited to, local time and date of the presentation, local weather, location of the event presentation to some level of detail, such as region, country, or street, capabilities of the presentation system, and user, viewer, or subscriber personal data, historical data, preferences, or subscription level. This information may be used in, or used in the construction of, the advertisement content, so that, for instance, such information may appear in the advertisement, including, but not limited to, the viewers name, the local city name, a local telephone number to call, and many other possibilities not mentioned. The historical data may include, but are not limited to, user or viewer advertising or product range interests, such as those indicated by previous advertising interactions or specified preferences, user or viewer preferred camera angles, types, or positions, such as for use in positioning advertising for higher probability of greater visibility, perceptibility, or impact, and user or viewer event preferences, viewing trends, or viewing preferences, such as for use in placing higher priority advertising in historically more frequently viewed events or event types, or more frequently viewed portions of an event.

Advertising content, including advertising determination information, may be supplied from a variety of sources and at a variety of times. Advertising content may be integrated into the event content, or may consist of one or more separate data sets. Entities which supply advertising content to presentation systems may include, but are not limited to, suppliers of event content or advertising servers. Advertising content may be supplied to a presentation system across a range of time spans, in relation to their appearance in a particular event presentation of event content, including, but not limited to, prior to the presentation system obtaining the event content, such as advertising content intended for some or all event presentations and distributed from advertising servers to some or all presentation systems, after the presentation system obtains the event content but prior to the event presentation, such as advertising content integrated with the event content or distributed from advertising servers to presentation systems known to have the event content, and during the event presentation, such as advertising content obtained from advertising servers during the initiation or performance of the presentation.

The present invention includes viewer interaction with advertisements where the viewer uses a human interface device communicating with the presentation system to indicate or detect information, such as a location or action or both. Advertisement content interactive functions may use the indicated or detected information for a variety of uses. Example uses include, but are not limited to, modifying advertisement based on the information, and compiling, storing, or communicating to a remote system some other information based on the information. Using a typical implementation of the present invention where the human interface device is a viewer controlled pointing device used to indicate a position within the display device and where the pointing device also includes a means for the viewer to indicate an action as with a button on the pointing device, such an implementation could be used by the viewer to indicate interest or disinterest in an advertisement. If interest is indicated by the viewer by, for instance, moving the pointer position to within the advertisement or by additionally moving the pointer position to a specific position within the advertisement and indicating an action, the advertisement may expand or change in some other way, or may cause the presentation to pause, or may cause a internet browser window to open showing an advertisement specific page, or may cause advertising information to be transmitted to the viewer or user, or some combination of these actions or other actions. Additional example interactions include, but are not limited to, viewer indicating their interest in an advertisement, such as rating an advertisement by clicking on a scale of ratings, viewer requesting an advertisement be removed, to stop or start animating, or video or audio playback to start or stop, such as by clicking on an appropriately indicated area on an advertisement. It should be clear to any practitioner of ordinary skill in the art that the specific examples given are illustrative, and should in no way restrict the scope of the present invention.

The present invention enables advertisement specific rendering, where an advertisement is rendered to the presentation devices using one or more custom rendering parameters instead of the default rendering parameters, so that, for instance, the advertisement is rendered in a manner different from the default rendering, which causes the advertisement to be, for instance, more noticeable or interesting. Also included in the present invention is the ability of the advertisement presented to the viewer to be modified based on the view point relative to the advertisement at the time of the presentation, or to be modified based on some other information available to the presentation system, so that, for instance, the angle, size, coloring, brightness or some other aspect of the advertisement changes based on its angle to, its distance from, its visibility through weather from, or some other aspect of the advertisement relative to, the view point. It should be clear to any practitioner of ordinary skill in the art that the specific examples given are illustrative, and should in no way restrict the scope of the present invention.

During an event presentation the presentation system has detailed information about what is presented to the viewer through the presentation devices. This detailed presentation information is used by the present invention for gathering analytic information on the advertising or potential advertising within the event presentation. A broad range of analytic information may be gathered, including, but not limited to, information for each advertisement, such as visibility over time, number of views, total time viewable, percentage of total visible advertising space over time, and viewer interactions. Such analytic information gathering algorithms or specifications may be transmitted remotely to the presentation system, such as from the event content provider or advertising server, or included in event content or advertising content, and may, for instance, be intended for use thereafter, or with the event content, or for the advertising content, or for some portion of the advertising content, such as for a single advertisement. Information specific to the presentation system or information derived from such specific presentation system information may be included in the advertising analytics. Examples of such presentation system specific information include, but are not limited to, presentation date or time of day, presentation device information, and viewer or user sex, age, location, viewing history, viewing preferences, or other viewer or user information. It should be clear to any practitioner of ordinary skill in the art that the specific examples given are illustrative, and should in no way restrict the scope of the present invention.

Advertising analytics may be gathered not just on advertising placed in the event presentation by the presentation system, but on advertising which was existent in the real world when the event occurred and was captured as part of the event content production process. Advertising analytics may also be gathered for potential advertising spaces, where such spaces do not contain the advertisement which the analytics are being gathered for, where the analytics are used to evaluate the value of the potential advertising spaces, or for some other use.

Advertising analytics gathered according to the present invention may be transmitted to locations remote to the local presentation system. These analytics may be transmitted to other locations for storage or for further analysis, possibly in combination with analytics from other presentations of the same event content, or in combination with analytics from other presentations from the same presentation system or viewer or user, or in other ways not specified here. What advertising analytics are gathered, what subsets, including the entire set, of these analytics are transmitted, and where each subset is transmitted to, may be determined by a variety of factors, including, but not limited to, user or viewer preferences, event content creator preferences, advertising server preferences, advertiser preferences, or other factors not mention here. It should be clear to any practitioner of ordinary skill in the art that the specific examples given are illustrative, and should in no way restrict the scope of the present invention.

Where advertising analytics transmittal is not immediately available, such as due to a failure in the transmission means, due to an interruption in the transmission path, or due to a failure to connect to the receiver of the advertising analytics, the advertising analytics may be saved by the presentation system until a later time if and when the transmittal of those advertising analytics becomes available.

The present invention provides systems and methods related to charging fees for including advertising within a presentation as described above, including, but not limited to, means to specify and price advertising space to advertisers, means for advertisers to select and purchase advertising space, means for advertisers to preview advertising content for an advertising space, means for advertisers to provide advertising content for an advertising space, means to sell advertising analytics, and means to provide advertising analytics to advertising analytics consumers. Advertisement pricing may depend on, for example, demographics specified, such as where the advertiser specifies that a certain segment of the users or viewers should receive their advertisement based on some aspect or aspects of the users or viewers characteristics, event content selected for advertising within, pricing other advertisers are willing to pay, extent of advertising analytics requested, actual views of the advertisement based on advertising analytics, or advertisement size, location, animation, interaction, presentation system resources needed, or complexity.

Although the present invention has been described with several embodiments and examples, numerous changes, substitutions, variations, alterations, and modifications are possible, including those which should be obvious to one skilled in the art, and it is intended that the invention encompass all such changes, substitutions, variations, alterations, and modifications as fall within the spirit and scope of the included claims, descriptions, and drawings.

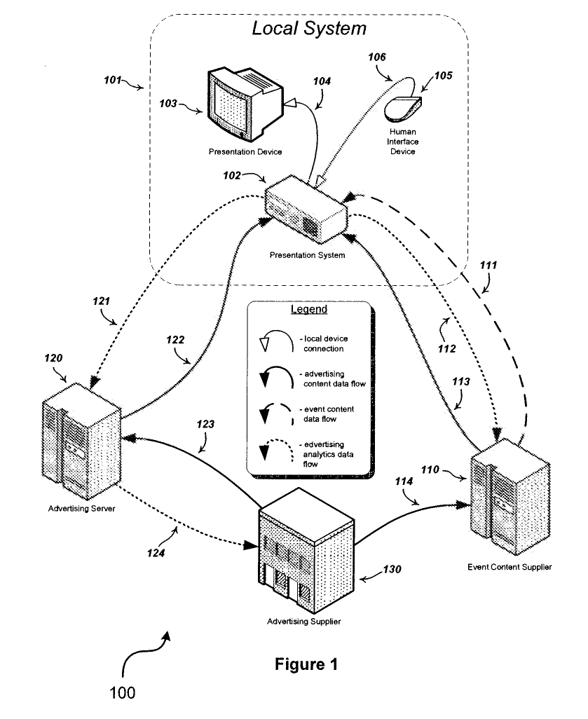

FIG. 1 illustrates an exemplary advertising system 100 for supplying and delivering real world event content with included and dynamically served advertising according to one embodiment of the present invention. System 100 further provides an exemplary system for the presentation of the content and advertising and for the delivery of the advertising analytics resulting from the presentation.

Referring to FIG. 1, group box 101 contains a representative local system used for an event presentation. Only a single local system is shown, but in practice there may be many such local systems as, for example, each customer, client, subscriber, or viewing area used for viewing, of the event presentation requires its own local system. Central to the local system is a presentation system 102, here shown as a single component but may comprise a plurality of interconnected components. A presentation device 103, shown on FIG. 1 as a display device, is supplied with presentation content by the presentation system over a local device connection 104. The presentation device shown is representational, and in practice one or more additional presentation devices may be present, including, but not limited to, sound output devices, additional display devices, and other sensory output devices.

System 100 also includes a human interface device 105, an event content supplier 110, an advertising server 120, and an advertising supplier 130. In one embodiment, device 105 is a computer mouse used to supply information to the presentation system over a local device connection 106. The human interface device shown is representational, and in practice may be absent, or one or more additional human interface devices may be present. The presentation device and human interface device local device connections may be wired or wireless connections.

Event content is supplied to the presentation system from the event content supplier 110 using a communication path 111. Communication path 111, or any communication path discussed herein, may be a network, such as the internet, or the physical transfer of a data storage device, such as a DVD or CD, or some other communications means. The supply may occur prior to the event presentation, such as with the purchase of a DVD containing the event content, or during the event presentation, such as with the live presentation of streamed event content, or a combination of prior to the event presentation and streamed live. The event content supplier shown is representational, and in practice may comprise a plurality of suppliers, systems, locations, or components.

Advertising content is supplied to presentation system 102 from the event content supplier using communication path 113. The communication path may be a network, such as the internet, or the physical transfer of a data storage device, such as a DVD or CD, or some other communications means. The supply may occur prior to the event presentation, such as with the purchase of a DVD containing the event content and advertising content, or during the event presentation, such as with the live presentation of streamed event content and advertising content, or a combination of prior to the presentation and streamed live. Advertising content is also supplied to presentation system 102 from the advertising server 120 using communication path 122. The communication path may be a network, such as the internet, or some other communications means. The supply may occur prior to the event presentation, during the event presentation, or a combination of prior to and during the event presentation. The advertising server shown is representational, and in practice may comprise a plurality of servers, systems, locations, or components.

As advertising analytics are compiled by presentation system 102 and are available to be transferred, such advertising analytics may be communicated to event content supplier 110 using a communication path 112 and to advertising server 120 using a communications path 121. Other advertising analytics receivers, not shown, may also receive advertising analytics supplied by the presentation system using similar communication paths. Advertising analytics may be communicated to advertising analytics receivers during the event presentation for which the advertising analytics are being compiled, or at some future time, possibly after storage on a locally connected data storage device such as a hard drive. If communication to an advertising analytics receiver is not possible at a time when such communication is attempted, such as a result of a malfunctioning Internet connection or an inability to connect to the advertising analytics receiver, the advertising analytics may be saved and later retrieved at such time that such communication is possible.

Advertising supplier 130 supplies advertising to advertising server 120 using communication path 123 and to event content supplier 110 using communication path 114. The supply may occur prior to the event presentation, during the event presentation, or a combination of prior to and during the event presentation. Advertising analytics may be communicated from advertising server 120 to the advertising supplier 130 using communication path 124. As mentioned, the communication path may be a network, such as the internet, or some other communication means. Other advertising analytics receivers, not shown, may also receive advertising analytics supplied by the advertising server, or supplied by the event content supplier, using similar communication paths. The advertising supplier shown is representational, and in practice may comprise a plurality of suppliers, systems, locations, or components.

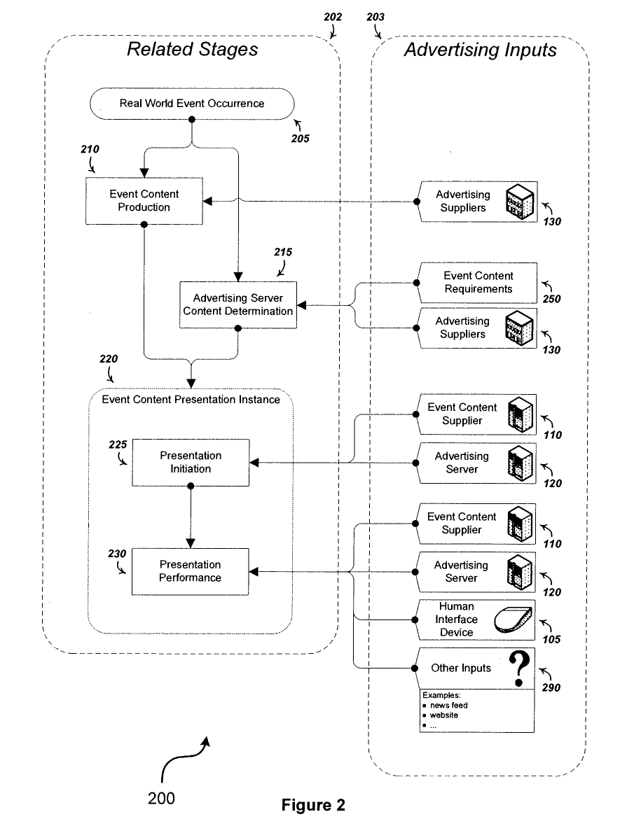

FIG. 2 illustrates an exemplary process flow 200 for the dynamic advertising related operation according to one embodiment of the present invention. Referring to FIG. 2, process flow 200 illustrates a process for advertising placed in a particular real world event content presentation instance, with inputs 203 providing information to various stages of flow 200.

Group box 202 contains the related stages in roughly chronological order. In practice the chronological order may be different, or stages may overlap chronologically. Stages are shown as a monolithic block of functionality, but in practice a stage may comprise a plurality of functional blocks, and the plurality of functional blocks may or may not be separated in time or location, and the functionality may operate on a plurality of computational devices.

Group box 203 contains the informational inputs, referred to here as advertising inputs, used by each stage for the stages dynamic advertising related functionality. Each advertising input, although shown as a single entity, may comprise a plurality of entities. A plurality of differently named advertising inputs may share a single entity. An advertising input, although shown, may not be used or may not be available due to the nature of the presentation system used for the event content presentation instance, or due to the requirements of the event content being presented, or due to some other reason.

The sequence begins at step 205 where a real world event occurrence is monitored and collected. Information collected at step 205 serves as the primary source of information for an event content production at step 210. Advertising included in the event content may be supplied by advertising suppliers 130 during event content production.

At step 215, advertising server content is determined using event content requirements 250 and advertising supplied by advertising suppliers 130. Event content requirements 250 may be supplied by the event content production, or from the event content, or both. Portions of the event content production or advertising server content determination may occur before each other or before or during the real world event occurrence. A typical scenario is with a live broadcast of a real world event, where certain information known prior to the real world event may be used to produce a portion of the event content prior to the real world event, such as models and textures, and where advertising server content determination is performed substantially or entirely prior to the real world event.

In step 220, the dynamic advertising related stages ‘event content presentation instance’ are shown. In step 225, the dynamic advertising operation, including advertising determination, may include the use of advertising content supplied with the event content, or acquisition and use of advertising content supplied prior to, or at the time of presentation initiation by the event content supplier 110 or advertising server 120 through a communications path such as internet download. The dynamic advertising operation, including advertising determination, may occur during step 230, ‘the presentation performance’.

Step 230 includes the use of advertising content supplied with the event content, or acquisition and use of advertising content supplied at the time of presentation initiation or presentation performance from event content supplier 110 or advertising server 120 through a communications path such as internet download. Dynamic advertising operation may utilize input from human interface device 105, where, for example, the input may indicate viewer interest, intention, or interaction with an advertisement. Other unspecified inputs 290 may be utilized for advertising determination, including, but not limited to, inputs from other types of viewer or viewing area sensing devices, and informational inputs such as news feeds, weather feeds, websites, and RSS feeds. Other information locally available to the presentation system may be used for advertising determination, including, but not limited to, past, current or predicted future rendering or simulation information, user or viewer related information, such as viewer preferences, location, or personal information, stored historical information, such as presentation or viewer preference history, presentation system capabilities, local location, date, or time, or any other locally available information.

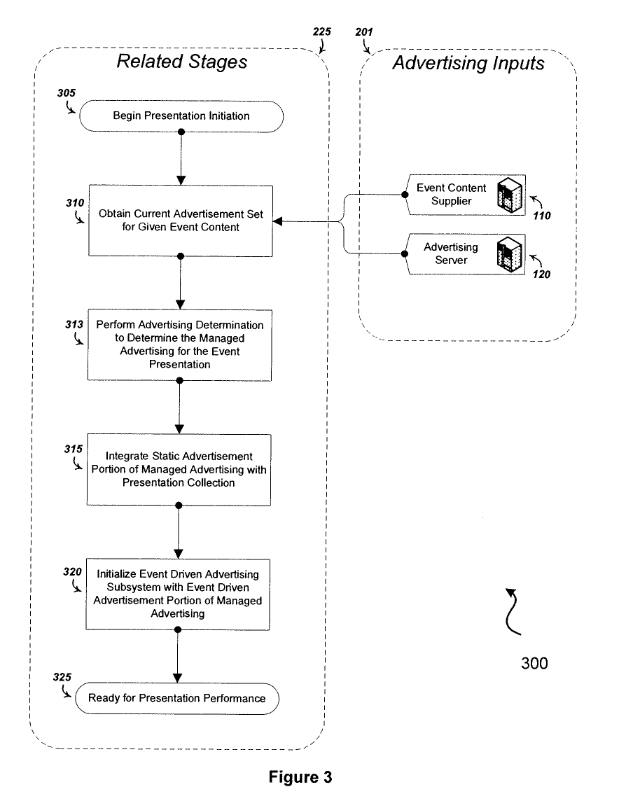

FIG. 3 illustrates an exemplary a process flow 300 that includes the presentation initiation portion of the dynamic advertising functionality for advertising placed in a particular real world event content presentation instance according to one embodiment of the present invention. FIG. 3 represents a more detailed view of presentation initiation 225 of FIG. 2 with inputs 203 providing information to various stages of flow 300. Note that for simplicity the use of the term event content used herein also encompasses the related presentation collection and available production collection terms, such that event content includes the production collections selected for use in the event presentation, and any encompassing production collection from which any selected production collection was extracted from.

Referring to FIG. 3, group box 225 contains the related stages performed during presentation initiation by the presentation system in roughly chronological order. In practice the chronological order may be different, or stages may overlap chronologically. Stages are shown as a monolithic block of functionality, but in practice a stage may comprise a plurality of functional blocks.

Similar to FIG. 2, group box 203 contains the informational inputs, referred to here as advertising inputs, used by each stage for the stages dynamic advertising functionality. Each advertising input, although shown as a single entity, may comprise a plurality of entities. A plurality of differently named advertising inputs may share a single entity. An advertising input, although shown, may not be used or may not be available due to the nature of the presentation system used for the event content presentation instance, or due to the requirements of the event content being presented, or due to some other reason.

The presentation instance starts at step 305, referred to as presentation initiation. In step 310, current advertising content is obtained from advertising content supplied with the event content, or acquisition and use of advertising content supplied prior to, or at the time of presentation initiation by the event content supplier 110 or advertising server 120 through a communications path such as internet download. The advertisement set is the collection of available advertising content applicable for the event content.

In step 313, advertising determinations are performed, which includes determining some or all of the managed advertising for inclusion in the event presentation, such as by prioritization and selection based on other means, and possibly determining various aspects of the presentation of those managed advertisements. Advertising determinations may also be performed during presentation performance, for, for instance, those advertising determinations requiring information available only at that time, if any, or for that advertising content received during presentation performance, if any.

The managed advertising is then available for initialization within the simulation. In step 315, the static advertisement portion of the managed advertising is integrated with the presentation collection such that the static advertisements will be depicted as specified during the presentation.

In step 320, the event driven advertising subsystem is initialized with the event driven advertisement portion of the managed advertising such that events specified in the event driven advertisements occurring during the presentation are detected and handled as specified. The managed advertising is now initialized within the presentation system and is ready for the presentation performance at step 325.

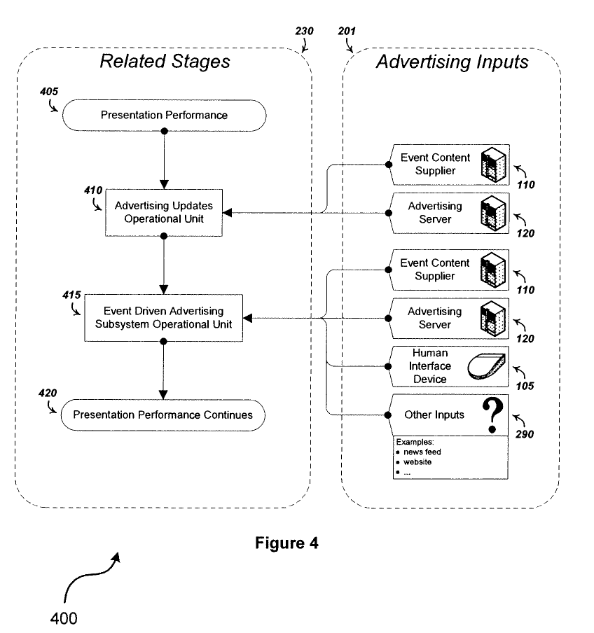

FIG. 4 illustrates an exemplary flow chart 400 illustrating the presentation performance portion of the dynamic advertising functionality for advertising placed in a particular real world event according to one embodiment of the present invention. Flow 400 illustrates a more detailed process flow of presentation performance 230 of FIG. 2, which starts at step 405. Similar to flow 300, information or inputs are provided to various stages of flow 400 by inputs 201.

In step 410, during the ongoing presentation performance 405, event content supplier 110 or advertising server is periodically checked for update of advertising content. In one embodiment, this task is performed by an advertising update operational unit. In one embodiment, the advertising content updates may be integrated into the presentation in a manner similar to that performed during presentation initiation, as described for FIG. 3.

In step 415, an event driven advertising subsystem periodically monitors available informational inputs, such as from event content supplier 110, advertising server 120, human interface device 105, or other unspecified inputs 290, and monitors other available local information. Information being monitored includes current rendered information or a computer simulation state. In one embodiment, the event driven advertising subsystem is also configured to perform other operations, such as incremental updates to currently ongoing event driven scripts, animations, or other operations triggered by a detected event, as specified by the event driven advertising. For example, the event driven advertising subsystem can be configured to monitor and detect when an indicator (positioned by a viewer using a human interface device such as a mouse, visible on a display device) overlaps a particular sufficiently visible event driven advertisement and react based on the detection. In one embodiment, one reaction based on the detection is to change the size and shape of the advertisement or perform a particular animation.

The ongoing presentation performance continues 420.

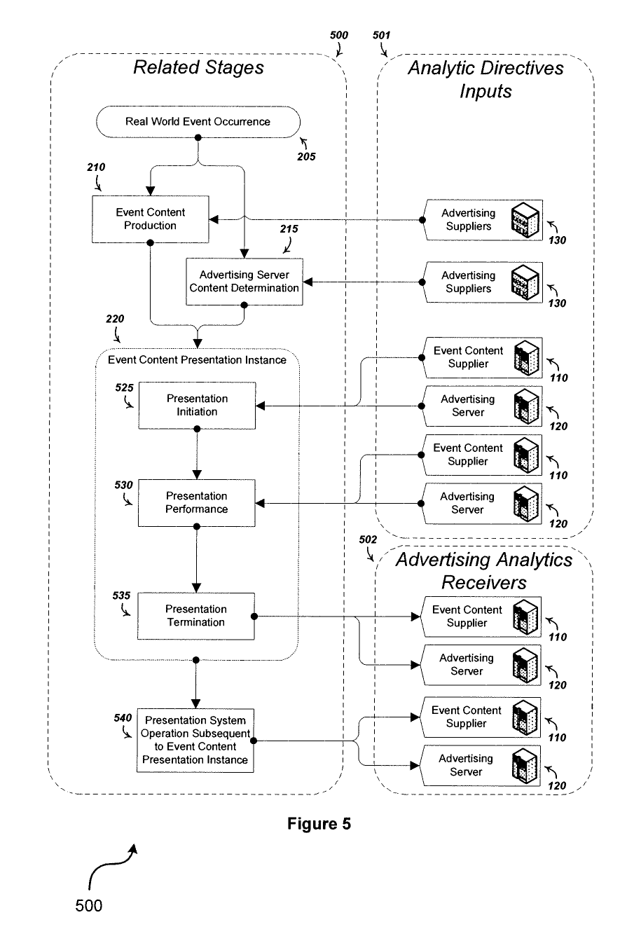

FIG. 5 illustrates an exemplary process flow 500 of an advertising analytics operation according to one embodiment of the present invention. Process flow 500 is described herein based on a particular real world event content presentation instance.

Referring to FIG. 5, group box 500 illustrates various stages of flow 500 in a rough chronological order. As mentioned, in practice the chronological order may be different, or stages may overlap chronologically.

Group box 501 contains the informational inputs, referred to here as analytic directive inputs, used by one or more stages of process flow 500. Each analytic directive input, although shown as a single entity, may comprise a plurality of entities. A plurality of differently named analytic directive inputs may share a single entity. An analytic directive input, although shown, may not be used or may not be available due to the nature of the presentation system used for the event content presentation instance, or due to the requirements of the presentation collection being presented, or due to some other reason. The analytic directive inputs may provide actual analytic directives, or may provide information used to determine analytic directives.

Group box 502 contains the receivers of advertising analytics informational generated from the event presentation, referred to here as advertising analytics receivers. Each advertising analytics receiver, although shown as a single entity, may comprise a plurality of entities. A plurality of differently named advertising analytics receivers may share a single entity. An advertising analytics receiver, although shown, may not be used or may not be available due to the nature of the presentation system used for the event content presentation instance, or due to the requirements of the presentation collection being presented, or due to some other reason. Other advertising analytics receiving entities, not shown, may receive advertising analytics, such as advertising analytics transmitted directly to an advertising supplier.

As shown in FIG. 5, flow 500 starts at step 205 where a real world event occurrence is monitored and collected. Information collected at step 205 serves as the primary source of information for an event content production at step 210. Advertising information included in the event content may be supplied by advertising suppliers 130 during event content production.

At step 215, advertising server content is determined using advertising suppliers 130. Step 215 may include analytic directives, such as for the advertising supplied by advertising suppliers 130. Portions of the event content production or advertising server content determination may occur before each other or before or during the real world event occurrence. A typical scenario is with a live broadcast of a real world event, where certain information known prior to the real world event is used to produce a portion of the event content prior to the real world event, such as models and textures, and where advertising server content determination is performed substantially or entirely prior to the real world event, including constructing analytic directives for the advertising or potential advertising for which advertising analytics are desired.

In step 220, the dynamic advertising related stages ‘event content presentation instance’ are shown. Step 220 contains the advertising analytics related stages, performed by the presentation system, of one instance of a presentation of the event content by the presentation system.

In step 525, the dynamic advertising operation, including advertising determination, may include the use of advertising content supplied with the event content, or acquisition and use of advertising content supplied prior to, or at the time of presentation initiation by the event content supplier 110 or advertising server 120 through a communications path such as internet download. The dynamic advertising operation, including advertising determination, may occur during a step 530, ‘the presentation performance’.

Step 530 includes the use of advertising content supplied with the event content, or acquisition and use of advertising content supplied at the time of presentation initiation or presentation performance from event content supplier 110 or advertising server 120 through a communications path such as internet download. Dynamic advertising operation may utilize input from human interface device 105, where, for example, the input may indicate viewer interest, intention, or interaction with an advertisement. The primary operation of advertising analytics functionality during presentation performance is the gathering of those advertising analytics as specified by the analytic directives. Advertising analytics operation may occur during a presentation termination step 535, including forming particular forms of advertising analytics from other advertising analytics collected during presentation performance, or transmittal of advertising analytics to event content supplier 110 or advertising server 120 through a communications path such as internet download, or storage of advertising analytics on a local data storage device.

In step 540, advertising analytic related operation of the presentation system subsequent to an event presentation may typically involve transmittal of advertising analytics to event content supplier 110 or advertising server 120. This transmittal operation may be preceded by the retrieval of advertising analytics previously stored on a data storage device. Such transmittal subsequent to event presentation may occur for a variety of reasons, including, for example, transmittal to an advertising analytic receiver at an earlier time was unavailable because of transmission means failure or advertising analytic receiver unable to receive at that time, or subsequent to the event presentation, the presentation system receives a request for advertising analytic transmittal from a remote entity, and the presentation system fulfills that request by the transmittal. Note that if any the transmittal is not possible for some reason, the transmittal may be rescheduled for, or retried at, a later time.

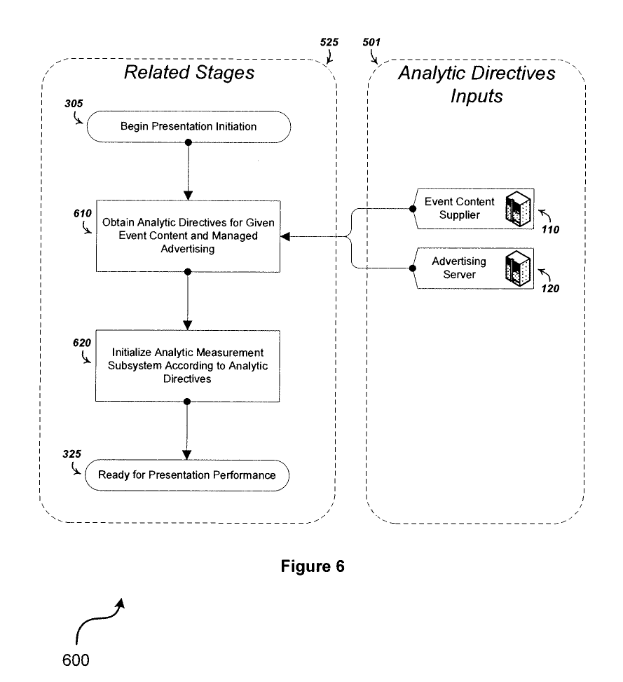

FIG. 6 illustrates an exemplary process flow 600 for the presentation initiation portion of the advertising analytics functionality for real world event content presentation instance according to one embodiment of the present invention. Flow 600 represents a more detailed view of step 525 of FIG. 5.

Referring to FIG. 6, group box 525 contains the related stages performed during presentation initiation by presentation system 102. A Group box 501 contains the informational inputs, referred to here as analytic directive inputs, used by one or more stages of process flow 600.

As shown, the presentation instance starts with the beginning of the presentation initiation 305. The analytic directives or inputs for the event presentation are obtained at step 610 from event content supplier 110 or advertising server 120, or from other advertising content selected for use in the event presentation. Managed advertising implemented by dynamic advertising functionality may include analytic directives, where those analytic directives are then supplied to advertising analytics functionality for implementation.

In step 620, the analytic measurement subsystem is initialized using the analytic directives obtained for the event presentation. In one embodiment, the analytic measurement subsystem is a component of the advertising analytics functionality which operates during presentation performance and collects analytics information by performing the analytic measurements specified in the analytic directives on the analytic units. In one embodiment, the analytic measurement subsystem is initialized so that it performs these analytic measurements on these analytic units during presentation performance.

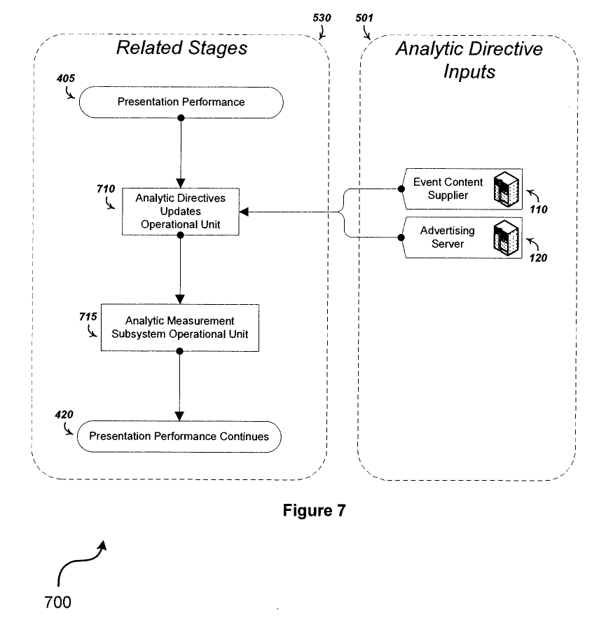

FIG. 7 illustrates an exemplary process flow 700 for the presentation performance portion of the advertising analytics functionality according to one embodiment of the present invention. Flow 700 represents a more detailed view of step 530 of FIG. 5.

As mentioned, group box 530 contains the stages performed during presentation performance by presentation system 102. Similarly, group box 501 contains the informational inputs, referred to here as analytic directive inputs, used by one or more stages of process flow 700.

Periodically during the ongoing presentation performance 405, an analytic directives updates operational unit may check for, or may be notified of, new analytic directives in step 710. These new analytic directives may be available from the event content supplier 110 or advertising server 120, or may be part of advertising content received during presentation performance from either of these entities. Any of these new analytic directives may be integrated into the presentation in a manner similar to that performed during presentation initiation, as described for FIG. 6, so that the analytic measurement subsystem also performs the analytic measurements on the analytic units as specified in these new analytic directives.

In step 715, the specified analytic measurements on the specified analytic units during the event presentation is performed. In one embodiment, this operation is executed periodically during the ongoing presentation performance.

Examples are discussed below to clarify the operation of the analytic measurement subsystem operation unit. Let us assume that the analytic directive has specified several advertising impact related analytic measurements on a single analytic unit. In this example, the analytic unit is an unmanaged advertisement, an advertisement which is included in the event presentation due to its presence in the event content as part of the visual models used for depicting the event. This advertisement may have been captured as a byproduct of producing the visual models for the event, or it may have been purposely included as a paid advertisement. This unmanaged advertisement is visually located in a particular location in the virtual world, and this location is specified in the analytic directive as the specified aspect of the advertisement sufficient for use as an analytic unit for the analytic measurements. The analytic measurements for this example perform advertising impact related measurements. Specifically, the analytic measurements include percentage of screen area over time, and advertising impressions calculated using a sophisticated formula based on the percentage of screen area, angle of advertisement relative to the screen, percentage of advertisement visible on the screen, amount of occlusion by other objects, lighting factors, and length of time continuously visible.

The percentage of screen area over time analytic measurement produces a table of percentages, each percentage for a short consecutive time slice, so that the table covers the entire time period of the event presentation, and where the percentage is a calculation of the percentage of the area on the display device occupied by the visual representation of the advertisement. The advertising impressions analytic measurement performs the described measurements, and if the criteria for an advertising impact are reached, various details about the context of that advertising impact are recorded. Both of these analytic measurements are performed periodically during the presentation performance. This periodicity may typically be every incremental update of the relevant presentation content by the presentation content production pipeline component. In the present example, this would be the incremental update to the presentation content for the display device, typically done at a rate of 30 or 60 display frames per second. Therefore, in the present example, for each new display frame throughout the event presentation, the analytic measurement subsystem performs the described analytic measurements.

The ongoing presentation performance continues 420.

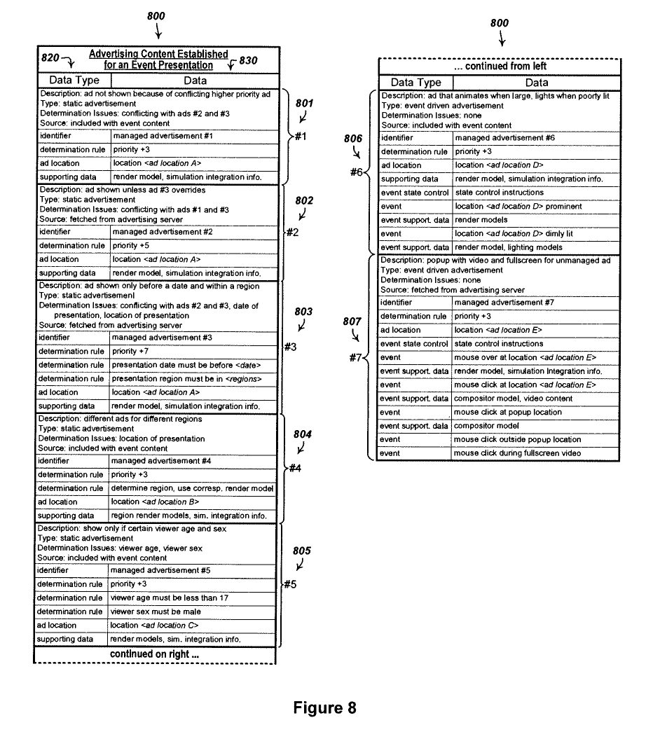

FIG. 8 illustrates an exemplary advertising content data set for a real world event content presentation instance utilizing the managed advertising functionality according to one embodiment of the present invention. The data set consists of advertising content for 7 managed advertisements, for interpretation and implementation by the managed advertising component of the presentation operation. The data set was established from various sources during presentation initiation, including from within the event content for the presentation and from one or more advertising servers. Note that for simplicity and clarity of explanation, in this example only advertising content from event content is referred to, while in an idealized embodiment advertising content may be included from any production collections from which the presentation collection is constructed, and not just the event content of that presentation collection as is the present case.

Each managed advertisement advertising content illustrated includes a information section, containing descriptive information not meant to represent a data set element, followed by the data set elements for that managed advertisement advertising content. The information section includes a ‘Description’ item briefly describing the main items of note for the managed advertisement, a ‘Type’ item indicating the managed advertisement type, a ‘Determination Issues’ item describing issues encountered during advertising determination, and a ‘Source’ item stating where the managed advertisement advertising content was obtained.

The data set elements include an identifier element, giving the managed advertisement a reference with which it may be referred to by other managed advertisements or other functionality. Managed advertisement may also be referred to by: one or more determination rule elements, specifying how to determine if the managed advertisement is included in the presentation and in some cases additionally how to determine the representation of the managed advertisement in the presentation; and an ad location element, specifying the location of the managed advertisement, such as a location within the simulation. Certain managed advertisement advertising content include a supporting data element, comprising various information used for implementation of the managed advertisement such as render models and virtual objects. Event driven advertisements include an event state control data element, containing rules or instructions for maintaining the state of the managed advertisement, and one or more event data elements, specifying an event which when detected may change the state of the managed advertisement. An event data element may have an associated event supporting data, comprising various information used for implementation of the features associated with the event, such as render models, compositor models, and video content.

Descriptive information shown in italics within angle brackets indicates that this information represents some specific value, and where some identifier is also included, that this information is different than other such specific values described with a different identifier. Uses of this in the present example include specifying the location for a managed advertisement, where the location is identified with a capitol letter, specifying a date, and specifying regions, where a region is a geographic region, such as country, county, state, city, or using some other divisions.

Referring to FIG. 8, table 800 illustrates the example managed advertisements according to one embodiment of the present invention. The data set element type for each data set element is shown in the ‘Data Type’ column 820, and a description of the contents of the data set element is shown in the ‘Data’ column 830.

Managed advertisement #1 advertising content 801 illustrates an advertisement which is not shown because another higher priority managed advertisement shares the same advertising location. The higher priority managed advertisement is shown instead. The priority of the managed advertisement is specified in a determination rule, with higher numbers representing higher priorities.

Managed advertisement #2 advertising content 802 illustrates an advertisement sharing the same advertising location with other managed advertisements, and which is higher priority than one of those managed advertisements but lower priority than another. This managed advertisement may or may not be shown depending on the advertising determination resulting from the determination rules of the other higher priority managed advertisement.

Managed advertisement #3 advertising content 803 illustrates an advertisement sharing the same advertising location with other managed advertisements, and which is higher priority than those managed advertisements but also depends on other determinations. This managed advertisement is specified to only appear in presentations which occur before a certain date, and is also specified to only appear in presentations which occur in locations within the specified geographical regions. If either of these conditions are not met then the managed advertisement does not appear in the presentation, and the next lowest priority managed advertisement sharing the same advertising location would be available for inclusion. The location of the presentation may be determined in a variety of ways, such as from information already present within the presentation system or from determining the location from the IP address of the local Internet connection.

Managed advertisement #4 advertising content 804 illustrates an advertisement whose representation in the presentation depends on the location where the presentation is occurring. The geographical region where the presentation is occurring is determined, and this region determines how the managed advertisement is implemented in the presentation. A simple implementation of this method would have a set of render models for each region, and the region of the presentation would determine the render models chosen for the managed advertisement.

Managed advertisement #5 advertising content 805 illustrates an advertisement whose inclusion in the presentation depends on determinations made about the viewers or possible viewers of the presentation. The viewer information available for this determination may be accurate for each actual viewer of the presentation, or something less accurate, such as information about the purchaser or a user of the presentation system, information about the purchaser of the event content, or information about the subscriber to a service used by the presentation system. In the present example, the viewer age and sex is used to determine if the managed advertisement will appear, so that the managed advertisement appears only if the viewer is male and less than 17 years old. In cases where this information cannot be accurately determined about the actual viewer, the best estimate using the means available is used.

Managed advertisement #6 advertising content 806 illustrates an event driven advertisement which modifies aspects of its implementation in the presentation content depending on aspects of its representation in the presentation content. In this example, those aspects deal with the visual appearance of the advertisement on the one or more display devices of the presentation system. Specifically, this event driven advertisement advertising content specifies an event detecting and handling the advertisement reaching a certain visual prominence, and another event detecting and handling the advertisement dropping below a certain minimal lighting.

During presentation, performance both of these events are checked for, and when an event is detected it is then handled as specified. Typically, the handling of an event results in a change of state of the event driven advertisement. In practice, additional states and detected events may be necessary, such as the detection of the advertisement leaving a previously detected and handled event. In the present example this may include detecting and handling an advertisement which is in the prominence event state but is no longer prominent enough to continue in that prominence state. The prominence event checks if the advertisement is visible on a display device, and if so, checks the size of the advertisement relative to the size of the display area of the display device. If this relative measure exceeds some defined value then the advertisement is sufficiently prominent and the event driven advertisement enters a new state, where it uses a different set of render models with included animations. The lighting event checks if the lighting on the advertisement is sufficiently bright, so that the advertisement is sufficiently visible. If the lighting is found to be deficient then the event driven advertisement enters a new state, where the advertisement is made more visible using a different set of render models are used, or using a different set of lighting models, or different renderer parameters.

Managed advertisement #7 advertising content 807 illustrates an event driven advertisement which provides additional advertising features for an unmanaged advertisement based on viewer interaction. This example event driven advertisement advertising content includes several events for detecting and handling various viewer interactions with parts of the advertisement. The viewer interaction is assumed to occur via viewer use of a mouse controlling a corresponding position indicator on a display device, and where the mouse has a button for which the viewer uses to indicate an action. An event detecting and handling a mouse over of the unmanaged advertisement causes a set of render models to be used overlaying the unmanaged advertisement, so that the advertisement visual appearance changes whenever the viewer moves the mouse pointer over the advertisement. An event detecting and handling a mouse click while the mouse pointer is over the unmanaged advertisement causes the presentation to pause and a video to begin playing in a popup window. An event detecting and handling a mouse click while the mouse pointer is over the video popup window causes the window to expand to the entire display area, showing the video full screen. An event detecting and handling a mouse click while the video is playing full screen causes the video to return to the video popup window. An event detecting and handling a mouse click outside the video popup window causes the video to stop playing, the popup window to disappear, and the presentation to resume from where it was paused. These events cause the event driven advertisement to change state, and this state, under control of the event state control, typically determines which events are checked for at any one time.

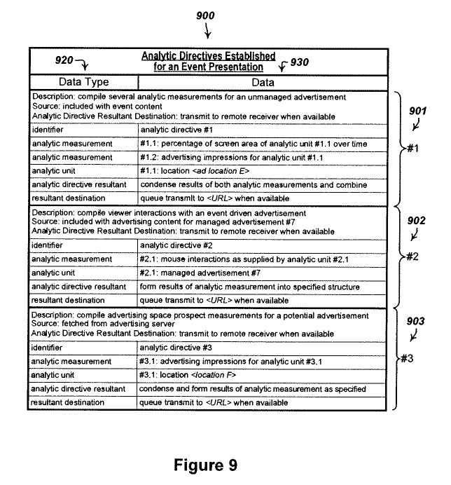

FIG. 9 illustrates an exemplary analytic directives data set for a real world event content presentation instance utilizing the advertising analytics functionality according to one embodiment of the present invention. The data set consists of analytic directives for 3 advertisements, for interpretation and implementation by the advertising analytics component of the presentation operation. The data set was established from various sources during presentation initiation, including from within the event content for the presentation, from an advertising server, and from within advertising content used for the presentation. Note that for simplicity and clarity of explanation, in this example only analytic directives from event content is referred to, while in an idealized embodiment analytic directives may be included from any production collections from which the presentation collection is constructed, and not just the event content of that presentation collection as is the present case.

Referring to FIG. 9, each analytic directive illustrated may include an information section, containing descriptive information not meant to represent a data set element, followed by the data set elements for that analytic directive. The information section includes a ‘Description’ item briefly describing the main items of note for the analytic directive; a ‘Source’ item stating where the analytic directive was obtained; and an ‘Analytic Directive Resultant Destination’ item stating the intended destination of the analytic directive resultant produced from the measurements gathered during the presentation.

The data set elements include an identifier element, giving the analytic directive a reference with which it may be referred to by other analytic directives or other functionality, one or more analytic measurement elements, specifying what measurements are to be performed during presentation performance, an analytic unit element, specifying the item to be measured, an analytic directive resultant element, specifying how to form the result of the analytic directive measurements gathered during the presentation performance, and a resultant destination element, specifying the destination of the analytic directive resultant. In this example, the analytic unit is either a location within the simulation or a reference to a managed advertisement, where that managed advertisement contains the information needed by the corresponding analytic measurements. A described analytic measurement may be built in functionality of the advertising analytics component, or it may be specified with measurement instructions within the analytic measurement element. These measurement instructions would utilize functionality of the advertising analytics component for their operation.

Each analytic measurement and analytic unit element includes a unique identifier for referencing by other elements. This identifier is defined at the beginning of the contents description for the element, and is of the form ‘#<analytic directive number>.<analytic measurement or analytic unit number>:’, where the descriptions inside the angle brackets are replaced with the described number. Identifiers of this form used as references in other elements refer to the element referenced by the identifier.

In this example, the resultant destinations all specify for the analytic directive resultant to be queued for transfer, then transmitted to the specified Internet destination when that destination is available for reception. Typically a queued analytic directive resultant would be stored on a local data storage device, preferably a hard disk drive if available, but other types of non-volatile data storage devices would work as well. The presentation system, perhaps due to functionality of the advertising analytics component, would check if the destination is available to receive a queue item, and if so, transmit that queue item to the destination. Once transmission of the queue item has been confirmed, that queue item is removed from the queue. In an idealized embodiment, this functionality would operate even outside of presentation operation, so that queue items may be transmitted while the presentation system is otherwise idle.

Descriptive information shown in italics within angle brackets indicates that this information represents some specific value, and where some identifier is also included, that this information is different than other such specific values described with a different identifier. Uses of this in the present example include specifying the location for an unmanaged advertisement or potential advertisement, where the location is identified with a capitol letter, and specifying a URL for use in Internet communications. Managed and unmanaged advertising references refer and correspond to items described in FIG. 8.

As shown in FIG. 9, table 900 illustrates the example analytic directives according to one embodiment of the present invention. The data set element type for each data set element is shown in the Data Type column 920, and a description of the contents of the data set element is shown in the Data column 930.

Analytic directive #1 901 illustrates specifications for compiling several analytic measurements for an unmanaged advertisement. The analytic measurements consist of measurements of the percentage of the display area occupied by the analytic unit over the period of time of the presentation, and measurements of advertising impressions of the analytic unit occurring during the presentation. A measurement of advertising impressions may involve how apparent the advertisement is and for how long. Examples of the functionality of these two analytic measurements are described in more detail in the description for FIG. 7. The analytic unit is an unmanaged advertisement, represented in the analytic unit element as a location in the simulation.

Analytic directive #2 902 illustrates specifications for compiling measurements of viewer interactions with an event driven advertisement. The analytic measurement consists of compiling information about the viewer interactions with the analytic unit, the analytic unit being in this case a reference to a managed advertisement. The referenced managed advertisement, managed advertisement #7, is described in detail in the description for FIG. 8. In this example the analytic measurement would not actually detect the viewer interactions, but would instead interface with the operation of managed advertisement #7, and would receive notice of any viewer interactions detected by the events of the managed advertisement, as these viewer interactions are already detected by the managed advertising functionality of this managed advertisement.

Analytic directive #3 903 illustrates specifications for compiling an analytic measurement for a potential advertisement. The analytic measurement consists of measurements of advertising impressions of the analytic unit occurring during the presentation. The analytic unit is a potential advertising space for which advertising analytics are desired. In practice the functionality for analytic measurements of potential advertisements and functionality for the same analytic measurements of unmanaged advertisements would likely be little different, as both types of advertisements are likely represented by the same type of analytic unit information, as neither type of advertisement likely exists as a distinct item within the presentation system operation, like, for instance, a managed advertisement does.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

The term tool may include used to refer to any apparatus configured to perform a recited function. For example, tools can include a collection of one or more modules and can also be comprised of hardware, software or a combination thereof. Thus, for example, a tool may include a collection of one or more software modules, hardware modules, software/hardware modules or any combination or permutation thereof. As another example, a tool may include a computing device or other appliance on which software runs or in which hardware is implemented.

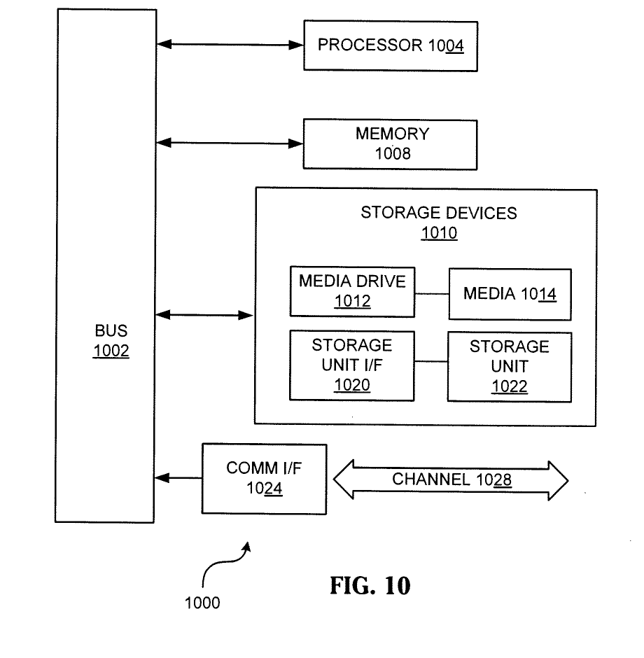

As used herein, the term module might describe a given unit of functionality that may include performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described may include shared in part or in total among one or more modules. In other words, as would be apparent to one of ordinary skill in the art after reading this description, the various features and functionality described herein may be implemented in any given application and may include implemented in one or more separate or shared modules in various combinations and permutations. Even though various features or elements of functionality may be individually described or claimed as separate modules, one of ordinary skill in the art will understand that these features and functionality may include shared among one or more common software and hardware elements, and such description shall not require or imply that separate hardware or software components are used to implement such features or functionality.

Where components or modules of the invention are implemented in whole or in part using software, in one embodiment, these software elements may include implemented to operate with a computing or processing module capable of carrying out the functionality described with respect thereto. One such example-computing module is shown in FIG. 10. Various embodiments are described in terms of this example-computing module 1000. After reading this description, it will become apparent to a person skilled in the relevant art how to implement the invention using other computing modules or architectures.

Referring now to FIG. 10, computing module 1000 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 1000 might also represent computing capabilities embedded within or otherwise available to a given device. For example, a computing module might be found in other electronic devices such as, for example, digital cameras, navigation systems, cellular telephones, portable computing devices, modems, routers, WAPs, and other electronic devices that might include some form of processing capability.

Computing module 1000 might include, for example, one or more processors or processing devices, such as a processor 1004. Processor 1004 might be implemented using a general-purpose or special-purpose processing engine such as, for example, a microprocessor, controller, or other control logic. In the example illustrated in FIG. 10, processor 1004 is connected to a bus 1002 or other communication medium to facilitate interaction with other components of computing module 1000.

Computing module 1000 might also include one or more memory modules, referred to as main memory 1008. For example, preferably random access memory (RAM) or other dynamic memory, might be used for storing information and instructions to be executed by processor 1004. Main memory 1008 might also be used for storing temporary variables or other intermediate information during execution of instructions to be executed by processor 1004. Computing module 1000 might likewise include a read only memory (“ROM”) or other static storage device coupled to bus 1002 for storing static information and instructions for processor 1004.

The computing module 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a floppy disk drive, a magnetic tape drive, an optical disk drive, a CD or DVD drive (R or RW), or other removable or fixed media drive. Accordingly, storage media 1014, might include, for example, a hard disk, a floppy disk, magnetic tape, cartridge, optical disk, a CD or DVD, or other fixed or removable medium that is read by, written to or accessed by media drive 1012. As these examples illustrate, the storage media 1014 can include a computer usable storage medium having stored therein particular computer software or data.

In alternative embodiments, information storage mechanism 1010 might include other similar instrumentalities for allowing computer programs or other instructions or data to be loaded into computing module 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory module) and memory slot, a PCMCIA slot and card, and other fixed or removable storage units 1022 and interfaces 1020 that allow software and data to be transferred from the storage unit 1022 to computing module 1000.

Computing module 1000 might also include a communications interface 1024. Communications interface 1024 might be used to allow software and data to be transferred between computing module 1000 and external devices. Examples of communications interface 1024 might include a modem or softmodem, a network interface (such as an Ethernet, network interface card, WiMedia, 802.XX or other interface), a communications port (such as for example, a USB port, IR port, RS232 port Bluetooth interface, or other port), or other communications interface. Software and data transferred via communications interface 1024 might typically be carried on signals, which may include electronic, electromagnetic, optical or other signals capable of being exchanged by a given communications interface 1024. These signals might be provided to communications interface 1024 via a channel 1028. This channel 1028 might carry signals and might be implemented using a wired or wireless medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1008, storage unit 1020, media 1014, and signals on channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1000 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that may include included in the invention. The invention is not restricted to the illustrated example architectures or configurations, but the desired features may include implemented using a variety of alternative architectures and configurations. Indeed, it will be apparent to one of skill in the art how alternative functional, logical or physical partitioning and configurations may include implemented to implement the desired features of the present invention. Also, a multitude of different constituent module names other than those depicted herein may include applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may include applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may include combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may include implemented without confinement to the illustrated examples. For example, block diagrams and their accompanying description should not be construed as mandating a particular architecture or configuration.

1. A method for managing advertisement in an event presentation, the method comprising:
establishing an advertising content to determine available managed advertisements for the event presentation;
implementing an advertising rule based on the determined managed advertisements;
determining a set of the available managed advertisements to be included in the event presentation based on the advertising rule; and
modifying the event presentation based on the determined set of available managed advertisements and the advertising rule.

2. The method of claim 1, wherein the managed advertisements are implemented in the event presentation by modifying one or more production collections used by the presentation content production of the event presentation, such that the modifications are according to the presentation specifics of the managed advertisements.

3. The method of claim 1, wherein the advertising rule is implemented during the event presentation.

4. The method of claim 1, wherein the implementation of the advertising rule is based on a presentation specific information.

5. The method of claim 4, wherein the presentation specific information comprises user interaction historical information based on user interaction using a human interface device.

6. The method of claim 1, wherein the set of available managed advertisements comprises an event driven advertisement, an advertisement event is based on a state of a renderer.

7. A system for managing advertisement in an event presentation, the system comprising:
a first content generator configured to generate advertising content, wherein the advertising content determines available managed advertisements for the event presentation;
a rule module configured to determine an advertising rule for the advertising content;
an advertisement module configured to determine a set of available managed advertisements to be included in the event presentation based on the determined advertising rule; and
a second content generator configured to manage the event presentation by modifying the event presentation based on the determined set of available managed advertisements and the advertising rule.

8. The system of claim 7, wherein the managed advertisements are implemented in the event presentation by modifying one or more production collections used by the presentation content production of the event presentation, such that the modifications are according to the presentation specifics of the managed advertisements.

9. The system of claim 7, wherein the advertising rule is determined concurrent with the event presentation.

10. The system of claim 7, wherein the advertising rule is determined based on a narrative event or a characteristic of a real world event.

11. The system of claim 10, wherein the narrative and the real world event comprise a human interface for a presentation content user to select one or more user specified depiction of the event presentation.

12. The system of claim 7, wherein the event presentation is modified to include information specific to a presentation device used to exhibit the event presentation.

13. The system of claim 7, wherein the advertising rule is determined based on information of a presentation device used to exhibit the event presentation.

14. A method for compiling advertising analytics for an event presentation comprising:
an analytic directive establishing an analytic measurement of an analytic unit performed during a presentation performance portion of the event presentation;
performing the analytic measurement resulting in an analytic directive resultant for the analytic directive; and
creating a transformed form based on the analytic directive resultant, wherein the transformed form is stored or transmitted to a remote device.

15. The method of claim 14, wherein the analytic measurement comprises a perceptibility measurement.

16. The method of claim 15, wherein the perceptibility measurement comprises a user perception of a characteristic of the event presentation.

17. The method of claim 14, wherein the analytic measurement comprises a measurement of a mouse pointer position.

18. The method of claim 14, wherein the advertising analytic comprises information of a presentation system used to exhibit the event presentation.

19. A system for compiling advertising analytics for an event presentation comprising:
a first module for establishing an analytic measurement of an analytic unit performed during a presentation performance portion of the event presentation using an analytic directive;
a second module for performing the analytic measurement resulting in an analytic directive resultant for the analytic directive;
a third module for creating a transformed form based on the analytic directive resultant, wherein the transformed form is stored or transmitted to a remote device.

20. The system of claim 19, wherein the analytic measurement comprises a perceptibility measurement.

21. The system of claim 20, wherein the perceptibility measurement comprises a user perception of the characteristic of the event presentation.

22. The system of claim 19, wherein the analytic measurement comprises a measurement of a mouse pointer position.

23. The system of claim 19, wherein the advertising analytic comprises information of a presentation system used to exhibit the event presentation.
